(19) United States
(12) Patent Application Publication
(10) Pub. No.: US 2016/0280879 A1
(43) Pub. Date: Sep. 29, 2016

(54) FLAME-RETARDED MATERIALS AND METHODS FOR FORMING THE SAME

(71) Applicant: CASE WESTERN RESERVE UNIVERSITY, Cleveland, OH (US)

(72) Inventors: Daniel Brannum, Xenia, OH (US); Gary Wnek, Cleveland, OH (US)

(21) Appl. No.: 15/079,980

(22) Filed: Mar. 24, 2016

Related U.S. Application Data
(60) Provisional application No. 62/181,449, filed on Jun. 18, 2015.
(60) Provisional application No. 62/137,477, filed on Mar. 24, 2015.

(51) Int. Cl. C08J 9/36

(52) U.S. Cl. CPC C08J 9/365; C08J 2201/038; C08J 2375/04; C08J 2389/04

(57) ABSTRACT

A process for flame-retarding base materials, such as fibers or foams with a metal oxide, such as silica, nanoparticle-containing composition and materials including a metal oxide, for example silica nano/micro particle-containing coating, layer, or networks. The process utilized allows properties of the coated material to be maintained. Flame-retarded materials are also disclosed. Heterogeneous dispersions of metal oxide, e.g. silica, particles on fibers or foams on a nanometer scale are described and/or the formation of networks/coatings in porous materials. In a particular embodiment, polymeric foams such as polyisocyanurate, polyurea and polyurethane foams include a metal oxide particle-containing coating layer or network that aids in char formation in the event the material is exposed to a flame.

### STATEMENT OF GOVERNMENT RIGHTS

This invention was made with government support under Contract No. P200A120040 awarded by the U.S. Department of Education. The government has certain rights in the invention.

### FIELD OF THE INVENTION

The present invention relates to a process for flame-retarding base materials, such as fibers or foams with a metal oxide, such as silica, nanoparticle-containing composition and materials including a metal oxide, for example silica nano/micro particle-containing coating, layer, or networks. The process utilized allows properties of the coated material to be maintained. Flame-retarded materials are also disclosed. Heterogeneous dispersions of metal oxide, e.g. silica, particles on fibers or foams on a nanometer scale are described and/or the formation of networks/coatings in porous materials. In a particular embodiment, polymeric foams such as polyisocyanurate, polyurea and polyurethane foams include a metal oxide particle-containing coating layer or network that aids in char formation in the event the material is exposed to a flame.

### BACKGROUND OF THE INVENTION

Flame retardants are compounds that can be added to a material that can suppress, inhibit, or delay the production of flames in hopes of stopping the spread of fire. These compounds are used in plastics, textiles, paints, coatings, and any other application where fire can be a relevant factor.¹ When considering a flame retardant, the three components of the fire reaction need to be examined; heat, fuel, and oxygen.² Without anyone of these, the fire will be prevented or quickly suppressed. Adding an appropriate amount of heat to a fuel and oxygen source initiates the process of combustion. Combustion is a highly exothermic chemical reaction between the fuel and oxygen; oxygen is usually supplied by the air. The process of combustion typically produces a flame that provides the heat needed until the fuel or oxygen source runs out. Since the majority of these reactions occur with hydrocarbons, the products of the reaction tend to be H₂O and CO₂. With the three factors that produce a fire, this leaves a large window to prevent or diminish a flame from being started. The reduction of heat can be accomplished by incorporating endothermic fillers that will absorb the heat to prevent the starting of fire. Dilution of the gas phase or gas phase radical quenching can cut out the oxygen that will keep a fire going. Finally, blocking the fuel through thermal shielding can prevent or stop a fire from continuing.³

The most widely known type of flame retardants are the highly controversial halogenated products. Chlorinated or brominated materials form radicals and react with the highly reactive H. and OH. radicals in the flame. Once H. and OH. are consumed, halogen radicals are not reactive enough to further propagate combustion. As byproducts, hydrogen chloride and hydrogen bromide gases are produced. Due to release of these toxic chemicals many bans and mandates to phase out these materials are currently in effect.⁴⁻⁵ Another method to decrease the amount of oxygen is by diluting it. The byproduct of burning a hydrocarbon is CO₂ and H₂O so by increasing the yield of those molecules it can slow their reaction rate by lowering the partial pressure of oxygen.⁶

Materials that release these byproducts do so by endothermic degradation. They take advantage of their ability to break down at lower temperature through endothermic reactions that absorb the heat that start fire. This can be accomplished by adding hydrated metal oxides/hydroxides such as aluminum hydroxide and magnesium hydroxide. Alternative natural approaches to this would be hydromagnesite and hunite mixtures which have lower endothermic decomposition temperatures compared with metal oxide/hydroxides noted above. However, the lower decomposition temperatures may limit polymer processing temperatures.⁷⁻⁸

Another way to stop or prevent the flame is by cutting off the fuel source via thermal shielding. Creating a thermal barrier between the burnt and unburnt parts is a successful way to extinguish an already existing flame. The main approach for this method is to use a material that swells upon heating which initiates the production of char that works as a thermal barrier. This can also be done by non-halogenated organophosphates that as a result of heating polymerize into a phosphoric acid sheet.⁹ By coating materials with silica, this thermal barrier is produced before the heat is applied and may encourage char instantly upon the application of heat. The drawback to this process is that coating a flexible or soft material with silica produces and hard stiff coated material.¹⁰

There continues to be interest in the promotion of char formation in polyisocyanurate and polyurethane foams, with new pre-foam formulations continuously under development. However, there appears to be a significant gap in the area of post-foam treatments that promote char formation. Toward that end, the inventors' laboratory has developed a major interest regarding new approaches for fire prevention and char formation in polymeric materials. This line of research focused on utilization of species of fresh-water algae that are inherently fire-resistant. Compositions of selected algae (cellulose with inorganic material such as silica or CaCO₃) were established, and a mechanism for fire resistance was proposed. The mechanism in essence is a competition between combustion and char formation with the latter capable of dominating if localized, immediate pyrolysis can be encouraged.

U.S. Pat. No. 6,197,415 relates to gel-coated materials that reportedly provide enhanced flame-, physical- and chemical-resistance to the foamed materials. The gel coatings can be created with a sol-gel process. Such treated materials can be used, for example, in the manufacture of articles of clothing that are to be used in environments in which fire and exposure to acids, bases or other chemicals which tend to corrode foamed materials is a potential hazard.

U.S. Pat. No. 6,197,415 also provides a method for produced gel-coated materials, by the method of sol-gel processing. In general, base materials as described therein are mixed with a sol which is allowed to cure into a gel, see Col. 9, lines 19-22. In Example 1, Ethanol (16.5 mL of 95% ethanol) and 63 mL of 98% tetraethyl orthosilicate (TEOS) were added to a 150 mL polypropylene or polymethyl propylene container, and mixed well. In a separate container, 20.4 mL of deionized water and 1.62 g of nitric acid were mixed. The acidic solution was added to the TEOS solution and stirred with a Teflon-coated stirring stick for 30 minutes. The mixture was observed to become warm and then cool as the reaction was completed. This material was placed in a shallow tray and a sample of open cell silicon foam was placed in the sol. The foam was soaked in the sol long enough to fully cover all surface, and then removed. Excess sol was removed by squeezing and wringing of the foamed material. Open cell foams may need to be squeezed while in the sol to ensure coverage of all exposed cell surfaces. The foam was left to cure overnight.

In view of the above, there is a continuing need for flame-retarded materials and methods for forming the same, wherein flame-retarding particles are formed on the surface of a base material or substrate which can, in some embodiments, allow for stronger and/or greater adhesion to the base material. This can allow, such as in the case of foams, the base material to undergo repeated compression and expansion.

### SUMMARY OF THE INVENTION

It is an object of the present invention to provide a process for flame-retarding base materials, in particular foams or fibers in some embodiments, with a metal oxide nano/micro particle-containing composition.

It is a further object of the present invention to provide flame-retardant materials including a metal oxide-containing, for example silica-containing coating, layer, or network on at least one surface of the material.

In a further embodiment, inorganic particles, preferably metal oxides such as silica, are synthesized from soluble precursors via sol-gel chemistry in the presence of base materials, such as polymeric materials in particular polymeric foams either open cell or closed cell foams, such as polyisocyanurate foams. An especially attractive approach for silica particle synthesis is the Stöber process involving tetraethyl orthosilicate (TEOS) and ammonium hydroxide:

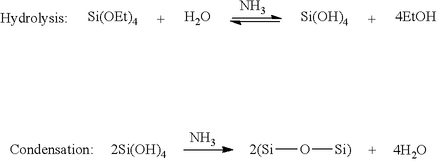

Samples with various loadings beginning from a few % by weight can be prepared and particle size and coverage studied by scanning electron microscopy. Thermal gravimentric analysis (TGA) in oxygen can be performed to determine the preference for char formation vs. combustion in terms of weight loss as a function of the amount of particle deposition. Limiting oxygen index (LOI) can be also determined as a function of extent of particle deposition. Combustion studies can be carried out using cone calorimetry. The ultimate goal is the development of a matrix relating silica particle synthesis variables (TEOS concentration, NH₄OH concentration, time) to the propensity for char formation. Optimal process conditions can be applied to deposit silica particles within foams of different chemical compositions and geometries.

Many entities are greatly interested in additives to promote char that can be incorporated into foam processing formulations. Toward that end, silica particles harvested from Stöber syntheses are used as an additive in polyisocyanurate and polyurethane foam preparations and char formation can be compared with post-foam deposition described above for comparable silica loadings. Of particular interest is whether there is a decided benefit of concentrating particles on foam wall surfaces in contrast to a more homogeneous incorporation within the foam itself.

A video of the burning of the treated urethane foam shown in the figures suggests at least roughly a sigmoidal transformation-time relationship for char growth which is a common characteristic of phase transformations.

In view of the above, various problems of the prior art are solved by the processes of the present invention which allow particles to form in situ on the surface of a base material and form nanoparticles as the reaction progresses. The resulting flame-retarded materials, in view of the process, can substantially maintain desirable mechanical properties in some embodiments. This is important, such as when the base material is a foam, such as polyurethane, which can undergo repeated compression and expansion cycles in normal application. By having the metal oxide particles attached to the base material through the methods of the present invention, greater movement is allowed, as compared to a uniform coating later-applied to a base material after formation. From a burning standpoint, the metal oxide particles attached to the base material according to the methods of the present invention, the particles have more surface area to absorb heat from a flame, potentially forming a char layer from the base material below it faster than a uniform coating. It is also possible in some embodiments for the particles to coalesce with each other, blocking oxygen from the fuel, acting as a metal oxide coating but without the compromise of rigidity.

A further aspect is a method for producing a flame-retardant material, comprising the steps of obtaining a composition comprising a metal oxide and a solvent; contacting the composition with a base material and forming, in situ, nanoparticles on a surface of the base material.

A further aspect is a flame retardant composite material, comprising a base material having metal oxide particles formed on a surface of the base material, when the base material comprises one or more of a foamed polymer and a fiber.

### BRIEF DESCRIPTION OF THE DRAWINGS

The invention will be better understood and other features and advantages will become apparent by reading the detailed description of the invention, taken together with the drawings, wherein:

FIG. 1 illustrates a cotton fiber coated in 7 nm of SEM gold;

FIG. 2 illustrates silica nanoparticles attached to cotton surface coated in 7 nm of SEM gold;

FIG. 3 illustrates burning of typical polyurethane cushion foam, with significant dripping of flaming material. Essentially nothing remains of the original foam piece;

FIG. 4 illustrates burning of polyurethane cushion foam treated by using silica particle deposition process. After a brief initial combustion event, the flame quickly diminishes without dripping of flaming material as char formation commences. Note the charred material retains original sample dimensions; and

FIG. 5 illustrates, on the left, an untreated polyurethane foam; in the middle, 0.5 M TEOS treated polyurethane foam; and on the right, 0.5 M TEOS treated polyurethane foam.

### DETAILED DESCRIPTION OF THE INVENTION

Methods for incorporating particles of metal oxide such as silica as a flame retardant onto a base material, such as a foam or fiber, preferably a fiber containing at least one OH (hydroxyl) group are disclosed. Materials including an in situ-formed metal oxide nano/micro particle-containing composition coating, layer, or network are disclosed. The method involves applying a heterogeneous coating onto the surface of a base material, for example a fiber, such as cotton or a foam. Silica has good adhesion to base materials including OH groups, such as cotton, by applying the Stöber and/or other sol-gel processes using tetraethyl orthosilicate (TEOS)¹¹⁻¹² to produce silica nano/micro particles.

Base Material

According to the invention, the coatings of the present invention including a metal oxide are produced on the surface of a base material. Various base materials can be utilized, for examples such as those set forth in U.S. Pat. No. 6,197,415, herein fully incorporated by reference.

As an example, the base material can be a foamed polymeric material. This material can be hydrophobic, hydrophilic, or amphipathic. Non-limiting examples of acceptable polymers include, but are not limited to, polyurethane, polyurea, polyolefins such as polypropylene, silicon resins, cellulose acetate, rubber such as neoprene, epoxy, polystyrene, phenolic resins, and halogen containing resins such as polyvinylchloride. Various combinations of the foams can be utilized as well, such as, but not limited to, urethane-urea, urethane-isocyanurate, urea-isocyanurate, and also urethane-urea-isocyanurate foams.

Compositions of the present invention are useful with open cell and closed cell foams.

As mentioned herein, the base material can also comprise a fiber or a material produced from a fiber such as a fabric. Suitable fabrics include those typically used for clothing materials, such as natural fabrics, including cotton, linen, wool, hemp, jute, ramie, silk, mohair, vicuna, and the like. Other fabrics include man-made fabrics such as, but not limited to, organic polymer fabrics including rayon, viscose, acetate, azlon, acrylic, aramid, nylon, olefin, polyester, spandex, vinyon and the like. The compositions of the present invention can be applied in essentially the same way to both fiber and fabric-type materials.

In addition to the base materials identified, it is important to note that the base materials may comprise additional components that may or may not effect the flammability thereof, such as various additives.

Particle-Forming Composition

The compositions applied to the base material include at least a solvent, metal oxide, and optionally but preferably a catalyst.

Metal Oxides

The term “metal oxide” when utilized herein includes and encompasses metal oxides, metal alkoxides, ceramic oxides as well as precursor materials in the form of water soluble or dispersible inorganic or organic compounds that are calcinable, or otherwise oxidizable to the corresponding metal oxide or a metalloid oxide.

Metal oxides for use in sol-gel processing are generally represented by M(—OH₂)ₙ (aquo ligand), M(—OH)ₙ (hydroxo ligand), and M(.dbd.O)ₙ (oxo ligand), where M is the metal atom, and n depends on the coordination state of M. Metal oxides for use in such reactions include TiO₂, ZrO₂, RuO₂, RuO₄, V₂O₅, WO₃, ThO₂, Fe₂O₃, MgO, Y₂O₃, HfO₂, Nb₂O₅, UO₂, BeO, CoO, NiO, CuO, ZnO, In₂O₃, Sb₂O₃, Al₂O₃ and SnO₂. Mixtures of such oxides are also useful, such as ZnO—TiO₂, TiO₂—Fe₂O₃, SnO₂—TiO₂, Nd₂O₃—TiO₂, Al₂O₃—Cr₂O₃, MgO—Al₂O₃, MgO—TiO₂, MgO—ZrO₂, ThO₂—UO₂, ThO₂—CeO₂, Bi₂O₃—TiO₂, BeO—Al₂O₃, TiO₂—Fe₂O₃—Al₂O₃, Al₂O₃—Cr₂O₃—Fe₂O₃, PbO—ZrO₂—TiO₂, ZnO—Al₂O₃—Cr₂O₃, Al₂O₃—Cr₂O₃—Fe₂O₃—TiO₂, and ThO₂—Al₂O₃—Cr₂O₃—Fe₂O₃—TiO₂. It is also within the scope of this invention to use dispersions or sols of the ceramic metal oxides in combination or admixture with dispersions or sols of one or more metal oxides which are unstable in normal air environment (such as Li₂O, Na₂O, K₂O, CaO, SrO, and BaO) and/or ceramic oxides having an atomic number of 14 or greater (such as SiO₂, As₂O₃, and P₂O₅), representative combinations including Al₂O₃—Li₂O, TiO₂—K₂O, ZrO₂—CaO, ZrO₂—Al₂O₃—CaO, ZrO₂—SrO, TiO₂—BaO, B₂O₃—SiO₂, TiO₂—ZrO₂—BaO, Al₂ 0.sub.₃—Na₂O, TiO₂—SiO₂, MgO—SiO₂, Fe₂O₃—BaO, ZrO₂—SiO₂, Al₂O₃—As₂O₃, ZrO₂—P₂O₅, Al₂O₃—SiO₂, Al₂O₃—B₂O₃, and Al₂O₃—Cr₂O₃—SiO₂.

Examples of precursor materials as noted above include, but are not limited to, carboxylates and alcoholates, e.g., acetates, formates, oxalates, lactates, propylates, citrates, and acetylacetonates, and salts of mineral acids, e.g., bromides, chlorides, chlorates, nitrates, sulfates, and phosphates, selection of the particular precursor compound being dictated by availability and ease of handling. Representative calcinable precursor compounds useful in this invention include ferric chloride or nitrate, chromium chloride, cobalt nitrate, nickel chloride, copper nitrate, zinc chloride or carbonate, lithium propylate, sodium carbonate or oxalate, potassium chloride, beryllium chloride, magnesium acetate, calcium lactate, strontium nitrate, barium acetate, yttrium bromide, zirconium acetate, hafnium oxychloride, vanadium chloride, ammonium tungstate, aluminum chloride, indium iodide, titanium acetylacetonate, stannic sulfate, lead formate, bismuth nitrate, neodymium chloride, phosphoric acid, cerium nitrate, uranium nitrate, and thorium nitrate.

Suitable metal alkoxide precursors are represented by the formula M(OR)ₙ, where M is a metal, OR is an alkoxide (an alkoxide with from one to six carbons which may be further substituted), and n is from 2 to 8, depending on the coordination state of the metal. The metals used in the metal alkoxide precursors are Ti, Cr, W, Th, Fe, Mg, Y, Zr, Hf, V, Nb, U, Be, Co, Ni, Cu, Zn, In, Sb, Al, Sn and Si. The alkoxy ligands are generally alkoxides with from one to six carbons such as methoxy, ethoxy, propoxy, butoxy, pentoxy, and hexoxy ligands, or substituted or unsubstituted aryloxy groups. Oligomeric precursors can be used such as ethoxypolysiloxane (ethyl polysilicate), hexamethoxydisiloxane (Si₂(OCH₃)₆) and octamethoxytrisilioxane (Si₃(OCH₃)₈).

The monomeric, tetrafunctional alkoxysilane precursors are represented by the following formula.

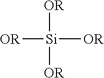

where RO is a C₁-C₆ substituted or unsubstituted alkoxy group, or a substituted or unsubstituted aryloxy group. Typical examples include methoxy, ethoxy, n-propoxy, n-butoxy, 2-methoxyethoxy, and phenylphenoxy groups. Ethoxypolysiloxane (ethyl polysilicate), hexamethoxydisiloxane (Si₂(OCH₃)₆) and octamethoxytrisilioxane (Si₃(OCH₃)₈) can also be used, as well as the cubic octamer (Si₈O₁₂)(OCH₃)₈. Organically modified silicates having various organic ligands can be used, such as those formed by combining tetraalkoxysilanes with alkyl-or aryl-substituted and organofunctional alkoxysilanes. Organic functionality can be introduced to the alkoxy ligands with substituents such as —(CH₂)ₙ₁NH₂, —(CH₂)ₙ₁NHCO—O—NH₂, —(CH₂)ₙ₁S(CH₂)ₙ₂CHO, and like substituents, where n1 and n2 are from 0 to 6. Polymerizible ligands can also be employed, such as epoxides, to form organic networks in addition to an inorganic network. Choice of precursor can be made according to solubility or thermal stability of the ligands.

To produce coatings with somewhat less dense structure, to impart more organic character to the coating, or to allow for derivitization, organotrialkoxysilanes (R′Si(OR)₃) or diorganodialkoxysilanes (R′₂Si(OR)₂) can be used as precursors. The groups R′ need not be the same as each other on a given precursor molecule. Examples of such precursors are methyltriethoxysilane, methyltrimethoxysilane, methyltri-n-propoxysilane, phenyltriethoxysilane, and vinyltriethoxysilane.

Catalysts

Catalysts are optional, but preferably present in the compositions of the invention. Acids and bases are suitable catalysts for processing as carried out in the invention. Preferred catalysts include inorganic acids (e.g., hydrochloric, nitric, sulfuric and hydrofluoric acid), amines including ammonia and ammonium hydroxide, organic acids (e.g., acetic acid), bases (e.g., potassium hydroxide), potassium fluoride, metal alkoxides (e.g., titanium alkoxide, vanadium alkoxide).

As mentioned above, the base or acid catalysis is optional and catalysts can be added in excess, knowing that the reaction, kinetics and size of particles produced are also a function of pH.

Solvents

The process of the present invention takes place in the presence of solvents. Suitable solvents include but are not limited to water, alcohols (e.g., methanol, ethanol), amides (e.g., formamide, dimethylformamide), ketones (e.g., acetone), nitrites (e.g., acetonitrile), and aliphatic or alicyclic ethers (e.g., diethyl ether, tetrahydrofuran, or dioxane). Water and alcohols are preferred solvents.

Particle Formation Processes

The particle forming compositions of the present invention are prepared in one embodiment by combining or contacting at least the metal oxide, catalyst, and base material. In a particularly preferred embodiment, the components of the particle-forming composition are contacted with the base material before an onset and completion, and preferably before the onset of a reaction between the catalyst and the metal oxide. This process step differentiates the process from that disclosed in U.S. Pat. No. 6,197,415, which requires the onset and completion of the reaction of the sol composition. It is only after the '415 reaction is complete that the sol is applied to the base material.

In the present invention, allowing the reaction to begin in the presence of the base material allows for the nanoparticles to form in situ onto the surface of the base material, forming nanoparticles as the reaction progresses. Higher concentrations of metal oxides can also produce a more uniform coating. Based on concentrations, we can dictate the exact amount of coverage on the surface of the base material, and in some embodiments preferably form a heterogeneous coverage of nanoparticles.

From a mechanical standpoint, by forming particles on the surface of the base material, strong adhesion is obtained between the metal oxide particles and the base material. This is especially important for a base material such as foam, especially a foam like polyurethane, which may undergo many compression and expansion cycles in normal application. The process of the present invention allows particulate attachment with freedom of movement of the base material.

Characterized in a different manner, the coating compositions of the present invention are applied to a base material prior to becoming warm or increasing greater than 5° C. above a highest pre-combination temperature of the components, in some embodiments. Combination of the coating compositions with the base material can be performed utilizing any suitable method in line with the goals of the invention of forming particles on the surface of the base material. Continuous baths can be utilized in some embodiments. An additional embodiment, the base material can be spray coated, in some embodiments, with the metal oxide component and catalyst component being sprayed from separate nozzles and coming into contact upon exit from the spray nozzles or on a surface of the base material or somewhere in between.

In additional embodiments, the base materials and components of the composition are combined and in a single step. An example of this is set forth in the Examples below wherein a high density polyurethane foam, TEOS, water, isopropanol, and ammonium hydroxide were combined and mixed.

The amount of metal oxide or TEOS was added at a 10 mL/1 gram of foam ratio. Water was added at the concentration equivalence equal to 6.25 times the concentration of TEOS ([H₂0]=6.25[TEOS]). Isopropanol was added based on the desired concentration of TEOS (0.1 M-5M for our studies). Ammonium Hydroxide was added at the concentration equivalence equal to 0.81 times the concentration of TEOS ([NH₃]=0.81 [TEOS]). Example using 1 gram of foam at a TEOS molarity of 1.5; 29.89 mL of 2-propanol, 10 mL of TEOS, 5.044 mL of water and 0.68 mL of ammonium hydroxide would all be mixed and reacted fully for 3 hours.

This not being limited to the above parameters in which the concentration of the metal oxide, such as silica alkoxide can be 0.05M-10M in relation to an alcohol. Water is added at a 1× to 100× molar equivalence to alcohol. Base or acid catalysis is optional and can be added in excess, knowing that the reaction kinetics and size of particles produced are also a function of pH. Kinetics and size of particles are also effected by the reactivity of the metal alkoxide, temperature of reaction, concentration ratios of all mixture constituents.

In view of the above, materials having flame retardant properties are disclosed, in particular polymeric materials, most particularly polymeric foams, such as, but not limited to polyurethane foams, polyurea and polyisocyanurate foams, wherein the materials include or otherwise comprise a silica nano/micro particle containing composition. Various combinations of the foams can be utilized as well, such as, but not limited to, urethane-urea, urethane-isocyanurate, urea-isocyanurate, and also urethane-urea-isocyanurate foams. A silica-containing coating, layer or network is present on at least one surface of the material. As indicated herein, the nano-micro particle sized silica can be incorporated onto or into the material prior to formation of the material or thereafter, as desired. The Stöber and/or other sol-gel processes using tetraethyl orthosilicate (TEOS) can be utilized. TEOS and other silica-containing chemicals are available from many commercial suppliers. In one embodiment metal oxide or silica particles can be produced having 1 or 10 nm to 5 micron size.

The methods can utilize various concentrations of alcohol, water and silica-containing compounds, such as TEOS. Particle/coating size can be manipulated by varying the concentrations. Different types of alcohols can produce different size particles as well. The concentration of the components determines if the resulting solution will produce a particle, coating, and/or network. Catalysts can be utilized if desired to increase reaction time. Catalysts in the system are also not limited. The reaction produced can be acid or base catalyzed, with base catalyzation generally being faster. The stronger the base or acid, the faster the reaction, in most instances.

Although the grade of TEOS used in the experiments described herein is 99%, lower grades of silica producing chemicals can be utilized in commercial applications. To produce the same result, changing the concentrations of solution materials might be necessary. TEOS and other silica containing chemicals are available from large chemical providers such as Sigma-Aldrich. Due to the versatility of the sol-gel process, silica particles can be produced from 10 nm to 5 micron size. The same length scale can be utilized for silica coatings and formation of silica networks within other materials.

Using a sol-gel process presents many opportunities to tune the concentrations of water, alcohol, and TEOS. In the below examples alcohol is in the highest concentration. To manipulate the particle/coating size water can be in the highest concentration. Also, utilizing different alcohols can produce different size particles. The same principles can be applied using different amounts of TEOS. The concentration of all three determines if the resulting solution will produce a particle, coating, and/or network. The resulting solution can also be left to react without the addition of a catalyst, although a catalyst is used to increase reaction time. Catalysts in the system are also not limited. The reaction produced can be acid or base catalization, due to the mechanism base catalyzed is faster. The stronger the base or acid the faster the reaction. Reaction rates can also influence whether the resulting silica is a particle, coating, or network. Cotton, silk, and high to low density polyurethane foams can all be successfully treated to produce flame retardant materials. Although those three materials have been tested the process is not limited to those materials. The process can be adapted to most materials with OH groups attached, and to most open pore foam network materials such as polyethylene or polyester foams.

### EXAMPLES

2.1 Reagents

Isopropanol, ammonium hydroxide, and ethanol were purchased from Fisher Scientific. Tetraethyl orthosilicate (TEOS) is GC grade with a purity of greater than 99% was purchased from Fluka. The water used throughout the process was deionized water. The cotton used was a typical cotton ball that was purchased at a grocery and/or drug store. The polyurethane foam used was a corrugated type that is used for packaging material and bed toppers. The silk was obtained through donation.

Experimental Procedures

Silica nanoparticles were synthesized using the process described by X.-D. Wang et al. In further detail, the reactions were carried out at concentrations of TEOS from 0.25-5.0 M. The determination of amount of water and ammonium hydroxide were based on the concentration of TEOS used in the system. Ammonium hydroxide concentration was equal to the concentration of TEOS times 0.81 whereas the concentration of water was 6.25 times the concentration of TEOS.

The calculated amount of isopropanol, water, and ammonia hydroxide was stirred for 5 minutes in a capped vile. The material was then added for another 5 minutes to ensure that the solution could fully permeate throughout. After this 10 minute process, the appropriate amount of TEOS was added slowly and capped to stir for 3 hours at room temperature. At the end of the 3 hours the solution was fully reacted and the excess was poured off and washed 4 times with ethanol and 4 times with water. The resulting nanoparticles were further examined. The same was done for the material that was now treated with silica nanoparticles.

The material and the resulting particles were tested for size and morphology with a field emission scanning electron microscope (FE-SEM). The material was then also burnt in comparison to the same weight material of a non-treated sample to observe and determine the amount of time and char formation.

Results and Discussion

Reaction System

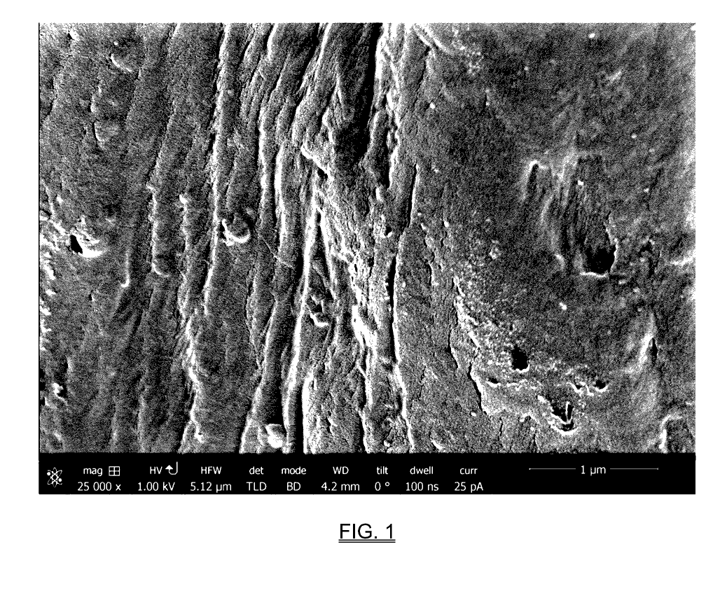

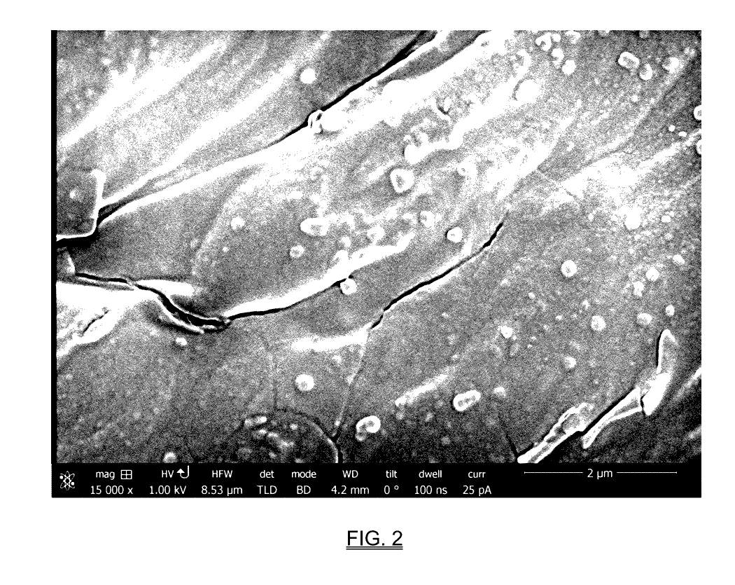

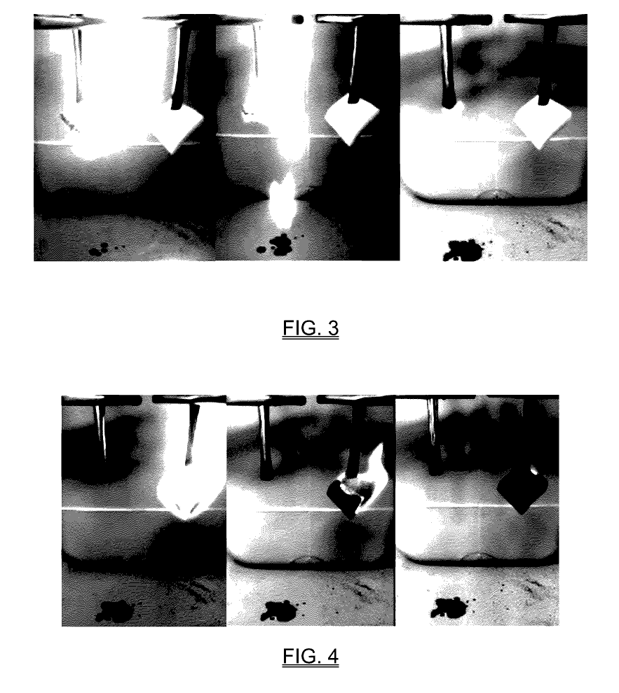

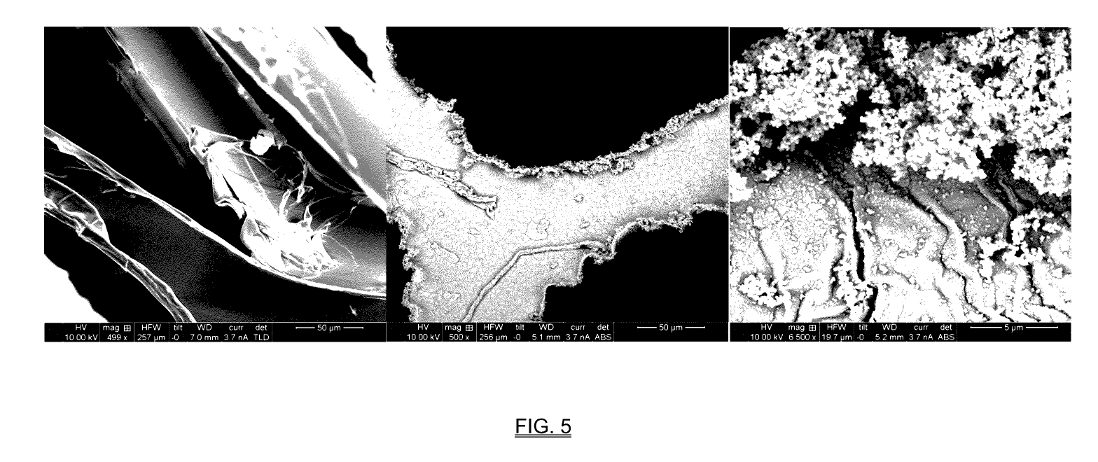

As discussed in further detail by X.-D. Wang et al., there are three important components to using the system chosen. Excess of water, low concentration of ammonium hydroxide, and high TEOS concentrations. An excess of water leads to the full hydrolysis of TEOS. The appropriate amount of NH3 as a catalyst so the reaction can be done in an appropriate amount of time without affecting the equilibrium extent of reaction. Finally, the high concentration of TEOS will lead to more particle formation, and in our case, more attachment to the desired materials. As shown in the FIG. 2 the particles are formed on the surface of the cotton fibers ranging from particle size between 200 and 600 nm compared to the untreated surface of cotton in FIG. 1.

Mechanism of Formation

Based on a review of the literature, there are two mechanisms for which the silica nanoparticles can be formed using this process. One is a controlled aggregation model with the other being monomer addition.¹³⁻²⁰ Since in our system there is another component, the monomer addition model can explain why there is attachment of nanoparticles to fibers such as cotton and silk fiber, but still leaves the mechanism for attachment to polyurethane up for discussion.

The formation of silica nanoparticles through monomer addition, although not completely agreed upon, is a fairly straight forward. Since TEOS can have four (Si—OH) functional groups this could be the core of the formed nanoparticles. In the solution there will also be numbers of TEOS molecules with 3, 2, and 1 functional group and as the concentration of TEOS in the solution goes down the more likely for the later. The fully functional TEOS will form the core and the partially functionalized molecules will start to polymerize and form oligomers until a TEOS with one functional group reacts and the polymerization will terminate.¹⁷ It is also possible that oligomers in the solution attach to each other and due to elastic and plastic deformation spherical particles can still form.¹⁶⁻¹⁷ When fibrous materials like cotton and silk are added to the solution the same concept applies. There are OH groups on the backbone of these materials and functionalized TEOS can attach and polymerized to the surface. With the addition of the desired material one would expect a resulting size to vary more than in the standard liquid solution.

In the case of the polyurethane foam the mechanism is still unclear. Because it is a foam there are already pores that can trap the particles into the material. Although possible this is unlikely because of the vast amount of washing the materials are put through before being tested. This also seems unlikely because when the material was burnt it acted the same as cotton did, in which the outside caught fire briefly and the char on the outside produced so rapidly that on the inside there was still some structural integrity. It also burnt without the melting effect that burning untreated polyurethane exhibited. Further investigation needs to be done to determine the amount of attachment to the foam surface to develop a more detailed understanding of the mechanism charring and flame inhibition.

Commercial Applications of Flame Retardants

The silica nanoparticle-containing compositions of the present invention can be applied as coatings to one or more of the following devices or parts of the devices mentioned:

### Electronics and Electrical Devices

Television and other electronic device casings
Computers and laptops, including monitors, keyboards and portable digital devices
Telephones and cell phones
Refrigerators
Washers and dryers
Vacuum cleaners
Electronic circuit boards
Electrical and optical wires and cables
Small household appliances
Battery chargers

### Building and Construction Materials

Electrical wires and cables, including those behind walls
Insulation materials (e.g., polystyrene and polyurethane insulation foams)
Paints and coatings which are applied to a variety of building materials, including steel
structures, metal sheets, wood, plaster and concrete
Structural and decorative wood products
Roofing components
Composite panels
Decorative fixtures

### Furnishings

Natural and synthetic filling materials and textile fibers
Foam upholstery
Foam mattresses
Curtains and fabric blinds
Carpets

### Transportation (Airplanes, Trains, Automobiles)

Overhead compartments
Seat covers and fillings
Seats, headrests and armrests
Roof liners
Textile carpets
Curtains
Sidewall and ceiling panels
   Internal structures, including dashboards and instrument panels
Insulation panels
Electrical and electronic cable coverings
Electrical and electronic equipment
Battery cases and trays
Car bumpers
Stereo components
   GPS and other computer systems

### REFERENCES

[1] U.S. Environmental Protection Agency (2005). Environmental Profiles of Chemical Flame-Retardant Alternatives for Low-Density Polyurethane Foam (Report). EPA 742-R-05-002A. Retrieved 4 Apr. 2013.
[2] Hantsfire.gov.uk, ‘Fire Triangle KidsZone::Hampshire Fire & Rescue Service’, 2014. (Online). Available: http://www.hantsfire.gov.uk/kids/learn/firetriangle.html. (Accessed: 11 Oct. 2014).
[3] Weil, E D; Levchik, S V (2009). Flame Retardants for Plastics and Textiles: Practical Applications. Munich: Carl Hanser Verlag. p. 97. ISBN 978-1-56990-454-1.
[4] “Market Study Flame Retardants”. Ceresana Research. Retrieved May 20, 2010.
[5] U.S. Environmental Protection Agency. 2010. DecaBDE Phase-out Initiative. Available: EPA.gov
[6] T. R. Hull, A. Witkowski and L. Hollingbery, ‘Fire retardant action of mineral fillers’, Polymer Degradation and Stability, 96 (8). pp. 1462-1469, 2011.
[7] L. Hollingbery and T. R. Hull, The thermal decomposition of natural mixtures of huntite and hydromagnesite', Thermochimica Acta, 528. pp. 45-52, 2012.
[8] Hollingbery, L A; Hull T R (2010). “The Fire Retardant Behaviour of Huntite and Hydromagnesite—A Review”. Polymer Degradation and Stability 95 (12): 2213-2225. doi:10.1016/j.polymdegradstab.2010.08.019
[9] I. Van der Veen and J. de Boer, ‘Phosphorus flame retardants: Properties, production, environmental occurrence, toxicity and analysis’, Chemosphere, 88 (10). pp. 1119-1153, 2012.
[10] Kashiwagi T, Gilman J W. Silicon based flame retardants. In: Grand A F, Wilkie C A, editors, Fire retardancy of polymeric materials, vol. 10. New York: Marcel Dekker Inc; 2000, p. 353-89.
[11] X. Wang, Z. Shen, T. Sang, X. Cheng, M. Li, L. Chen and Z. Wang, ‘Preparation of spherical silica particles by Stöber process with high concentration of tetra-ethylorthosilicate’, Journal of colloid and interface science, vol. 341, no. 1, pp. 23-29, 2010.
[12] W. Stöber, A. Fink and E. Bohn, ‘Controlled growth of monodisperse silica spheres in the micron size range’, Journal of Colloid and Interface Science, vol. 26, no. 1, pp. 62-69,1968.
[13] D. L. Green, J. S. Lin, Y. F. Lam, M. Z.-C. Hu, D. W. Schaefer, M. T. Harris, J. Colloid Interface Sci. 266 (2003) 346-358.
[14] C. G. Tan, B. D. Bowen, N. Epstein, J. Colloid Interface Sci. 118 (1987) 290.
[15] T. Matsoukas, E. Gulari, J. Colloid Interface Sci. 132 (1989) 13.
[16] G. H. Bogush, C. F. Zukoski I V, J. Colloid Interface Sci. 142 (1991) 19.
[17] A. van Blaaderen, A. P. M. Kentgens, J. Non-Cryst. Solids 149 (1992) 161.
[18] S. L. Chen, P. Dong, G. H. Yang, J. J. Yang, Ind. Eng. Chem. Res. 35 (1996) 4487-4493.
[19] S. Sadasivan, A. K. Dubey, Y. Li, D. H. Ramussen, J. Sol—Gel Sci. Technol. 12 (1998) 5.
[20] D. L. Green, S. Jayasundara, Y. F. Lam, M. T. Harris, J. Non-Cryst. Solids 315 (2003) 166-179.

While in accordance with the patent statutes the best mode and preferred embodiment have been set forth, the scope of the invention is not limited thereto, but rather by the scope of the attached claims.

What is claimed is:

1. A method for producing a flame-retardant material, comprising the steps of:
obtaining a composition comprising a metal oxide and a solvent;
contacting the composition with a base material and forming, in situ, nanoparticles on a surface of the base material.

2. The method according to claim 1, wherein the composition further includes a catalyst.

3. The method according to claim 2, wherein the base material comprises one or more of a fiber and a foamed polymeric material.

4. The method according to claim 3, wherein components of the composition are contacted with the base material before onset and completion of a reaction between the catalyst and the metal oxide.

5. The method according to claim 4, wherein the components are contacted with the base material before onset of the reaction between the catalyst and the metal oxide.

6. The method according to claim 1, wherein the composition is contacted with the base material prior to increasing greater than 5° C. above a highest pre-combination temperature of the components of the composition.

7. The method according to claim 3, wherein the contacting comprises sprang the composition on a surface of the base material wherein the metal oxide component and catalyst component are at least sprayed from separate nozzles and may come into contact upon exit from the spray nozzles or on a surface of the base material or somewhere therebetween.

8. The method according to claim 1, wherein the nanoparticles are adhered to the surface of the base material such that the base material may undergo compression and expansion cycles.

9. The method according to claim 1, wherein the metal oxide is present in a range of 0.05 M to 10 M in relation to an alcohol that is present as the solvent, wherein water is also present as a solvent and is present in an amount of 1 to 100 times the equivalence to the alcohol.

10. A flame retardant composite material, comprising:
a base material having metal oxide particles formed on a surface of the base material, when the base material comprises one or more of a foamed polymer and a fiber.

11. The composition material according to claim 10, wherein the base material comprises the foamed polymer.

12. The composition material according to claim 11, wherein the foamed polymer is an open-cell foam.

13. The composition material according to claim 11, wherein the foamed polymer is a closed-cell foam.

14. The composition material according to claim 10, wherein the metal oxide comprises one or more of titanium, zirconium, ruthenium, vanadium, tungsten, thorium, iron, magnesium, yttrium, hafnium, niobium, uranium, beryllium, chromium, cobalt, nickel, copper, zinc, indium, aluminum, tin, lithium, sodium, potassium, calcium, strontium, barium, silicon, arsenic, and phosphorus,

15. The composition material according to claim 10, wherein the metal oxide comprises one or more of aluminosilicate, borosilicate, and titanosilicate.

16. The composition material according to claim 10, wherein the metal oxide comprises a metal alkoxide.

17. The composition material according to claim 16, wherein the metal alkoxide is a tetraalkoxy silicone.

18. The composition material according to claim 17, wherein the tetraalkoxy silicone is one or more of tetramethoxy silicone, tetraethoxy silicone, and tetrapropoxy silicone.
